(19) United States
(12) Patent Application Publication
(10) Pub. No.: US 2008/0191832 A1
(43) Pub. Date: Aug. 14, 2008

(54) Chip-type fuse and method of manufacturing the same

(75) Inventor: Chon-Ming Tsai, Taipei (TW)

Correspondence Address: BIRCH STEWART KOLASCH & BIRCH, PO BOX 747, FALLS CHURCH, VA, 22040-0747, US

(73) Assignee: BESDON TECHNOLOGY CORPORATION

(21) Appl. No.: 11/802,694

(22) Filed: May 24, 2007

(30) Foreign Application Priority Data
Feb. 14, 2007 (TW) 096105420

(51) Int. Cl. H01H 85/04; H01H 69/02

(52) U.S. Cl. 337/297; 29/623

(57) ABSTRACT

A chip-type fuse is based on an electrically insulating substrate and fusible element is disposed thereon. A protective layer is formed over the fusible element and adheres to the substrate around the fusible element so as to define a cavity between the protective layer and the fusible element. The cavity isolates the protective layer from direct contact with the fusible element so that the protective layer will not be melted or breached by the excessive heat and arc generated by the fusible element under overload condition. Further, the cavity can be hermetically sealed to enclose a gas of pressure less than one atmosphere. A thermally insulating layer and an arc suppressive layer may be incorporated to reduce the response time and arc intensity of the chip-type fuse respectively under overload condition. The method of manufacturing chip-type fuse, particularly the method of forming fusible element and cavity, is described too.

### BACKGROUND OF THE INVENTION

1. Field of the Invention

The invention relates to a chip-type fuse that is mounted directly onto the surface of printed circuit board. Particularly, the invention relates to a chip-type fuse with a cavity over fusible element and the method of manufacturing such kind of fuse. Further, the cavity can be hermetically sealed to enclose a gas of pressure less than one atmosphere.

2. Description of the Prior Art

Fuses are widely applied in electrical and electronic industry to protect the circuits from damage and probable fire disaster caused by overload current. It's known that heat is generated while electrical current flows through the fusible element with predetermined resistance. Therefore, the fusible element is melted and destroyed by excessive heat so as to substantially isolate the circuit under overload condition, which is called clearing action. The higher resistance post clearing action means better isolation. Generally speaking, the fusible element of larger cross-sectional area has lower resistance and higher current rating. The fuse is serially connected with the circuit to be protected. Voltage drop across the fuse and temperature rise of the fuse is preferred to be as low as possible under rated current operation. Besides, it should be noted that arc is typically generated across the fusible element at clearing action. The generated arc is a kind of rapid and localized high energy, which is very destructive and must be carefully considered while designing and manufacturing a fuse.

A traditional fuse is constructed by a hollow insulator, which is made of glass or ceramic. A narrow fusible element, which is usually made of an alloy of silver and copper, is installed inside the insulator. Additionally, two metal caps are pressed to the two opposing ends of the insulator so as to electrically connect the fusible element. The heat and arc generated through the fusible element are confined inside the hollow insulator. The traditional fuse is serially connected with the circuit to be protected by means of a fuse holder soldered onto circuit board. Such a fuse is replaceable and has been utilized by the industry for many years, generally in the application of the power input of electrical and electronic products. However, the size of the traditional fuse is too big to meet the miniaturization requirement of current electronic products of which popular small size is 5 mm diametric by 20 mm long.

To meet the needs of miniaturization, the industry has introduced chip-type fuses featuring small sizes in recent years. The popular size is 1.6×0.8 mm and 3.2×1.6 mm (length×width) to be surface-mounted onto circuit boards. Because of its small size, the chip-type fuse is not only used in the power input but also in the internal circuits of the product to provide multi-level protections. Besides, manufacturing cost of chip-type fuses is lower than that of traditional fuses by allowing higher level of automation.

A conventional chip-type fuse is shown in FIG. 1. Referring to FIG. 1, the chip-type fuse 1 comprises a substrate 11, a fusible element 12, a protective layer 19, two terminals 14, and two termination pads 16. The substrate 11 is electrically insulating, which is usually rectangular made of alumina, glass or polymer. The fusible element 12 is composed of metals such as gold, silver, aluminum, copper, platinum and so on, and is deposited upon the surface of substrate 11 by thin film techniques of sputtering and evaporation. The two termination pads 16 consist of metals and electrically connect with the two ends of the fusible element 12 respectively. The termination pads 16 are usually wider than the fusible element 12. As shown in FIG. 1, the material and thickness of termination pads 16 and the fusible element 12 are preferred to be the same in order to lower manufacturing cost.

The two conductive terminals 14 are formed on the side surfaces of the two opposing ends of the substrate 11 to connect with the two ends of fusible element 12 respectively via the two termination pads 16. Terminals 14 are contact pads when the chip-type fuse 1 is mounted onto the circuit board. The protective layer 19, comprising glass or temperature-resistant polymer, overlays the fusible elements 12 and the surface of substrate 11 to protect the fusible element 12 from moisture, oxidation, and mechanical impact in the environment.

The conventional chip-type fuse 1 described above is concisely constructed. However, the protective layer 19 contacts the fusible element 12 directly and is subject to a thermal stress from the heat generated by the fusible element 12 even under rated current operation. The long-term reliability of chip-type fuse 1 is thus discounted. It's particularly critical that the protective layer 19 will be melted or breached by the excessive heat and arc generated across the fusible element 12 under overload condition. Therefore, the molten metals of fusible element 12 may pop out to endanger the metallic elements on the circuit board where the chip-type fuse 1 is mounted, which might result in the possibility of fire disaster.

U.S. Pat. No. 5,726,621 and 6,034,589 disclose chip-type fuses to improve the drawbacks described above. The patents split one fusible element of high current rating into multiple fusible elements of low current rating connected in parallel. A dielectric layer, composed of a mixture of glass and ceramic, isolates the two adjacent fusible elements by multi-layered stacking vertically. In this way, current flowing through the fuse is uniformly distributed to the multiple fusible elements. The mentioned patents practically improve the thermal stress, melting, and breaching of protective layer under overload condition but don't solve the problems thoroughly because the fusible element still directly contacts the dielectric. Moreover, the multi-layered stacking increases the manufacturing cost substantially.

So, the scope of the invention is to provide a chip-type fuse with a cavity over the fusible element to solve above described problems.

### SUMMARY OF THE INVENTION

A scope of the present invention is to provide a chip-type fuse with a cavity over the fusible element. This invention is based on an electrically insulating substrate and conductive fusible element is disposed thereon. A protective layer is formed over the fusible element and adheres to the substrate around the fusible element so as to define a cavity between the protective layer and the fusible element. The cavity isolates the protective layer from direct contact with the fusible element so that no thermal stress is induced in the protective layer. Long-term reliability of the chip-type fuse is then ensured. The most important feature is that the protective layer will not be melted or breached by the excessive heat and arc generated by the fusible element under overload condition. Further, the cavity can be hermetically sealed to enclose a gas of pressure less than one atmosphere.

Another scope of the present invention is to provide a method of manufacturing chip-type fuses with a hermetic cavity. Firstly, a sacrificial layer of polymer-based material is coated upon a plurality of identical fusible elements disposed on a large substrate. A protective layer containing glass powders is applied to overlay each sacrificial layer. An unsealed cavity is then formed between the fusible element and the protective layer after removing the sacrificial layer by heating. Afterwards, the whole protective layer melts at elevated temperature, adheres to the substrate around the fusible element, and seals the cavity after cooling. Finally, the large substrate is divided into a plurality of individual chip-type fuses by dicing of a diamond blade or laser.

A further scope of the present invention is to provide an integration of thin-film and thick-film techniques to produce a fine and low-resistance fusible element at inexpensive cost. An electrically conductive film of silver and glass composite is deposited onto the surface of a large substrate by thick-film printing and firing. Thin film techniques of photoresist polymer coating, photo-exposure, development, and chemical etching are then applied to form a plurality of fine fusible elements from the electrically conductive film. As a result, the width of the fusible element can be produced as small as 20 microns, wherein silver serves as electrically conductive media and glass as adhesive media.

The advantage and spirit of the invention may be understood by the following recitations together with the appended drawings.

### BRIEF DESCRIPTION OF THE APPENDED DRAWINGS

FIG. 1 is a perspective view of a conventional chip-type fuse;

FIG. 2 is a perspective view of a chip-type fuse according to a preferred embodiment of the present invention;

FIG. 3 is a cross-sectional view of FIG. 2;

FIG. 4 is a perspective view of a chip-type fuse according to another preferred embodiment of the present invention;

FIG. 5 is a cross-sectional view of FIG. 4;

FIG. 6 is a top view of the method for fabricating fusible elements and thermally insulating layers of the present invention;

FIG. 7 is a top view of the method for fabricating arc suppressive layers of the present invention;

FIG. 8 is atop view of the method for fabricating sacrificial layers of the present invention;

FIG. 9 is a top view of the method for fabricating protective layers and cavities of the present invention;

FIGS. 10A, 10B, 10C are cross-sectional views partially taken from FIG. 9 illustrating the steps for fabricating a protective layer and a cavity of the present invention; and

FIGS. 11A, 11B are top views of the method for fabricating terminals and methods for separating individual chip-type fuses of the present invention.

### DETAILED DESCRIPTION OF THE INVENTION

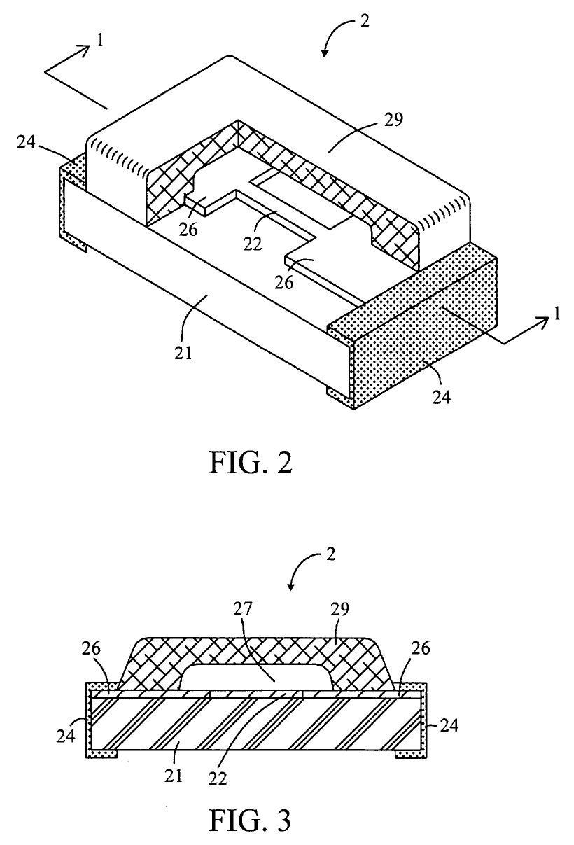

Referring to FIG. 2, a perspective view of chip-type fuse 2 according to a preferred embodiment of the invention is depicted. The protective layer 29 is partially removed to reveal the internal structure. FIG. 3 is a cross-sectional view of FIG. 2 along the centerline of width (1-1 line). Chip-type fuse 2 comprises a substrate 21, a fusible element 22, a cavity 27, a protective layer 29, two terminals 24, and two termination pads 26.

The substrate 21 is made of alumina of more than 90% purity, glass, or other electrically insulating ceramics. Alumina of 96% purity is very popular with a thickness of 0.2 to 1.0 mm.

The fusible element 22 is an electrically conductive film disposed over the surface of substrate 21. The fusible element 22 consists of pure metal or alloy including gold, silver, aluminum, copper, platinum, etc., or a composite of silver and glass. The two ends of fusible element 22 are electrically connected with the two conductive termination pads 26 respectively. The termination pads 26 are usually wider than the fusible element 22. The material and thickness of termination pad 26 can be same as or different from that of the fusible element 22. To lower manufacturing cost, the material and thickness of the termination pads 26 and the fusible element 22 are preferably the same as shown in FIG. 2 and FIG. 3.

In general, the fusible element 22 has a width of 20 to 200 microns approximately and a thickness of about 0.2 to 20 microns depending on the current rating requirement. A wider or thicker fusible element 22 usually results in lower electrical resistance and higher current rating. For example, the rated current is around 2 amperes for a silver fusible element 22 of 70 microns wide and 5 microns thick. The configuration of the fusible element 22 may be straight, serpentine, or irregular, and the electrical resistance is proportional to the total length of the element. The fusible element 22 may be a single line segment or a plurality of identical line segments linked in parallel.

The cavity 27 is formed over the fusible element 22 and preferably contains the whole fusible element 22. The length or width of the cavity 27 is about 200 to 2000 microns. The protective layer 29 comprises glass with the melting temperature between 400 to 600° C. preferably. The protective layer 29 is applied over the fusible element 22 and adheres to the substrate 21, directly or via the termination pads 26, around the fusible element 22 to seal the cavity 27.

The cavity 27 may not be hermetically sealed so that the internal gas is the same as surrounding environment, which is atmospheric air in most of the applications. However, it's highly preferred that cavity 27 is hermetically sealed to enclose a gas of pressure less than one atmosphere such as Nitrogen, Argon, dry air, another gases, or vacuum. The hermetically sealed cavity 27 provides the fusible element 22 a stable and safe environment to avoid the damage from moisture, other hazardous gases, or chemicals. Because the length or width of cavity 27 is as small as 200 microns, or 0.2 mm, the fabrication of chip-type fuses equal or less than 1.6×0.8 mm (length×width) is feasible.

Because the cavity 27 isolates the protective 29 from direct contact with the fusible element 22, the thermal stress developed in the protective layer 29 is substantially reduced or eliminated under the rated current operation. Since the gas inside the cavity 27 is an excellent buffer material, the protective layer 29 will not be melted or breached by the excessive heat and arc generated by the fusible element 22 under overload condition. In addition, the protective layer 29 is more robust to gas pressure increase under excessive heat if the cavity 27 is hermetically sealed to enclose a gas less than one atmosphere. Preferably, the height of the cavity 27 is about 10 to 500 microns. The expected isolation will not be realized if the height is too low. On the other hand, the fabrication cost will be substantially increased due to a high cavity.

The two conductive terminals 24 are formed on the side surfaces of two opposing ends of the substrate 21, and connect with the two ends of fusible element 22 respectively via the two termination pads 26. Terminals 24 are constructed by 3-layer material to function as contact pads when the chip-type fuse 2 is mounted onto the circuit board. The inner layer is silver-containing material, or a metallic film that adheres well to the substrate 21 such as pure metal or alloy of titanium and chromium. The middle layer is usually made of nickel, while the outer layer is made of tin.

Samples of chip-type fuses according to the preferred embodiment of the invention were fabricated to compare with conventional ones. The fusible element was made of silver having rated current of 2 amperes approximately. Testing method was to measure clearing time and electrical resistance after clearing by applying overload current of 30 amperes (input voltage is set as 32 volts). Also, the tested samples were inspected visually under a microscope.

Experimental Example was a preferred embodiment of the invention wherein cavity 27 had a length or width of 200 to 400 microns and a height of 50 to 200 microns. Protective layer 29 comprising glass hermetically sealed the cavity 27 to enclose dry air inside, with a pressure of 300 mmHg around.

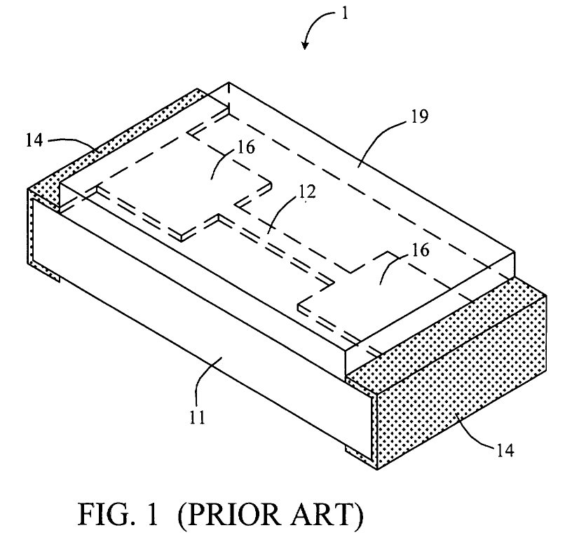

Comparative Example 1 was a conventional chip-type fuse as shown in FIG. 1, wherein a thin protective layer 19 of glass with a thickness of 10 to 20 microns overlaid and contacted the fusible element 12.

Comparative Example 2 was a conventional chip-type fuse as shown in FIG. 1, wherein a thick protective layer 19 of glass with a thickness of 100 to 200 microns overlaid and contacted the fusible element 12.

The fusible element cleared very rapidly, less than 1 millisecond, because the testing current was extremely higher than the rated current. The cleared resistance was above 10,000 ohms. No conclusive difference was measured for the two test items in these three examples.

However, visual inspection under the microscope after testing revealed significant differences. The protective layer 29 of Experimental Example remained intact and there were no visible signs of melting, breaching or other damages. But, the thin protective layer 19 of Comparative Example 1 was melted and metallic tip of the fusible element 12 was exposed outside the protective layer 19 sometimes. In contrast, the thick protective layer 19 of Comparative Example 2 was breached and popped out partially to expose two metallic tips of the fusible element 12. The exposure of metallic tip of the fusible elements 12 indicated that the molten metals already popped out, which might endanger the metallic elements on the circuit board where the chip-type fuse was mounted.

The test demonstrates that preferred embodiment of the invention has significant advantages over conventional chip-type fuses. The integrity and safety of the invented chip-type fuses are ensured because the protective layer will not be melted or breached by excessive heat and arc under extreme overload condition.

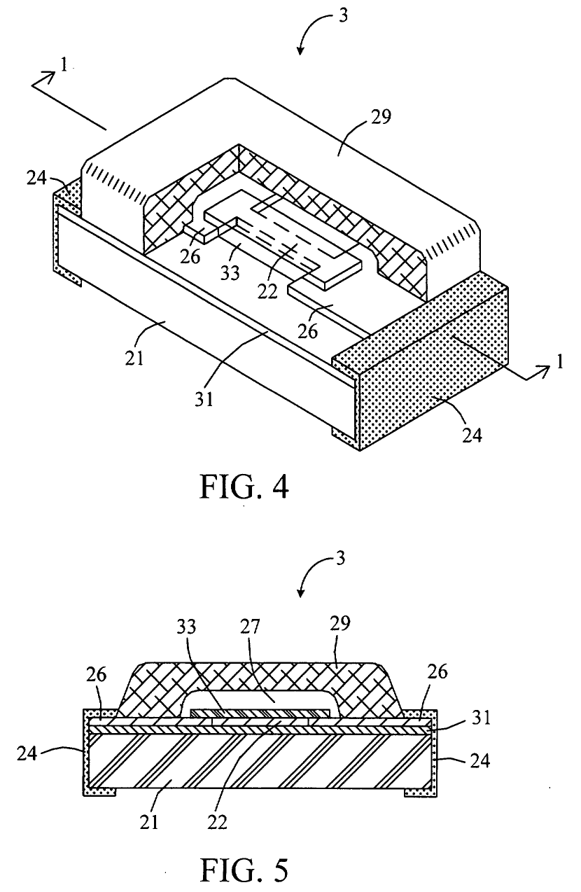

FIG. 4 and FIG. 5 show chip-type fuse 3 in accordance with another preferred embodiment of the invention. FIG. 4 is a perspective view wherein the protective layer 29 is partially removed to reveal the internal structure. FIG. 5 is a cross-sectional view of FIG. 4 along the centerline of width (1-1 line). Chip-type fuse 3 comprises a substrate 21, a fusible element 22, a cavity 27, a protective layer 29, two terminals 24, and two termination pads 26, which are identical to those of the chip-type fuse 2 of a preferred embodiment mentioned above.

Further, the chip-type fuse 3 comprises a thermally insulating layer 31 interposed between the substrate 21 and the fusible element 22, and an arc suppressive layer 33 that overlays the fusible elements 22.

The substrate 21 is made of alumina of more than 90% purity, glass, or other electrically insulating ceramics. Among them, alumina of 96% purity with a thickness of 0.2 to 1.0 mm is much preferred since such kind of alumina is highly temperature-resistant and corrosion-resistant at affordable price. But, the thermal conductivity of alumina is quite good so that a substantial amount of the heat generated by the fusible element 22 is dissipated through the substrate 21. It means that the fusible element 22 will require higher current and longer time to clear under overload condition.

Therefore, a thermally insulating layer 31 is interposed between the substrate 21 and the fusible element 22 to limit the heat transfer from the fusible element 22 to the substrate 21 for a fast acting fuse. The thermally insulating layer 31 comprises glass with a melting temperature of 600 to 1000° C. preferably. Because glass has much lower thermal conductivity than alumina, it's a preferred choice for thermal insulator at high temperature.

Due to the effect of thermally insulating layer 31, the heat generated under overload condition is retained in the fusible element 22. The clearing time of the fusible element 22 is substantially reduced so as to quickly respond to the overload current. Besides, the long-term reliability of the substrate 21 is improved because the heat transferred to the substrate 21 and the associated thermal stress is substantially reduced under rated current operation. The thickness of the thermally insulator 31 is about 5 to 100 microns. And, a thicker thermally insulating layer often results in better thermal insulation at higher fabricating cost.

A fusible element 22 made of silver of 1 ampere rating was cited as an example. Under overload current of 4 amperes, the clearing time was around 25 milliseconds when the fusible element 22 directly contacted the substrate 21. Under the same condition, the clearing time was reduced to just 1 millisecond when a thermally insulating layer 31 with a thickness of 10 to 20 microns was interposed between the substrate 21 and the fusible element 22. The comparison reveals that the thermally insulating layer 31 greatly speeds up the response of the fusible element 22 to overload current.

The thermally insulating layer 31 may suffuse the substrate 21 or just cover a portion of the substrate 21 as long as its area is large enough to isolate direct contact between the fusible element 22 and the substrate 21. Please note that the thermally insulating layer 31 is not required if the substrate 21 is made of glass or other material with good thermal insulation. In addition, slow acting chip-type fuse does not require the thermally insulating layer 31 either.

The arc suppressive layer 33 is made of glass or glass/ceramic mixture that at least overlays the whole fusible element 22 to suppress the arc density under overload condition. Melting temperature of the arc suppressive layer 33 is around 500 to 700 ° C., which must be lower than that of the fusible element 22. It is understood that the fusible element 22 starts to melt locally and forms a micro gap by the heating of overload current. As the overload current continues to flow through the fusible element 22, discharge across the micro gap occurs to generate an arc. The arc is a kind of rapid and localized high energy that is very destructive to the fusible 22 and the adjacent materials. Higher current and higher voltage usually results in higher arc density.

A fusible element 22 made of silver is cited as an example to illustrate how the arc suppressive layer 33 works. Temperature of the fusible element 22 rises very fast by overload current and heat is transferred to the overlaying arc suppressive layer 33. The arc suppressive layer 33 melts as liquid after the temperature goes over its melting point. As the temperature continues to rise to the melting point of silver (960 ° C.), the fusible element 22 starts to melt locally and forms a micro gap. Therefore, the liquid arc suppressive layer 33 flows inside the micro gap to limit current discharge across the micro gap. Arc intensity is thus suppressed.

The thickness of the arc suppressive layer 33 is around 5 to 100 microns. More thickness usually results in better suppression. The arc suppressive layer 33 may be confined inside the cavity 27 to overlay the whole fusible element 22. Alternatively, it may be extended to the outside of the cavity 27 to be interposed between the protective layer 29 and the thermally insulating layer 31, or between the protective layer 29 and the termination pads 26.

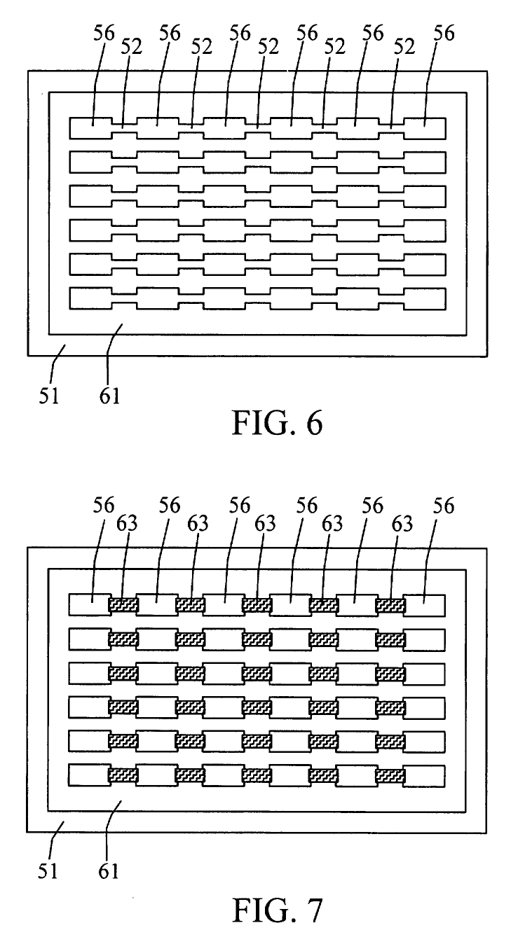

FIG. 6 through FIG. 9 and FIG. 10A through FIG. 10C illustrate the manufacturing method of chip-type fuses of the present invention. The size of the chip-type is usually very small and a practical method of mass production is to simultaneously process multiple fuses on a large substrate. Finally, the large substrate is divided into a plurality of individual chip-type fuses.

As shown in FIG. 6, a large substrate 51 is provided, which is electrically insulating and temperature-resistant made of alumina of more than 90% purity, glass, or other ceramics. The outline of substrate 51 is usually rectangular with 50 to 150 mm at one side. Hundreds or thousands of fuses can be disposed onto a substrate 51 depending on the size of the fuse.

Firstly, a thermally insulating layer 61 is fabricated onto the substrate 51. Powders of glass or glass/ceramic composite are mixed with solvents and binders to form a paste, which have been well known in the art. The paste is then printed onto surface of the substrate 51 by screen or stencil and is dried to remove the solvent at 50 to 150° C. The thickness of the thermally insulating layer 61 can be increased by repeating the printing and drying steps. After that, the substrate 51 is placed into a furnace to heat up to the melting temperature of the glass, which is preferably 600 to 1000° C., to form a thermally insulating layer 61 after cooling. Fusible elements 52 and termination pads 56 are then fabricated on the surface of the thermally insulating layer 61. The fusible elements 52 are electrically conductive films with a thickness of 0.2 to 20 microns and a width of 20 to 200 microns depending on the current rating. The fusible elements 52 can be made of pure metal or alloy of gold, silver, aluminum, copper, platinum, etc. by thin film techniques such as sputtering and evaporation. Sputtering is usually used for the film with a thickness less 1 micron because of its high fabricating cost. For the film with a thickness more than 1 micron, a hybrid method is quite practical to deposit a thin base layer by sputtering and increase the film thickness by the inexpensive plating technique. After the electrically conductive film is deposited, a photoresist polymer is patterned on the surface of the film by photo-exposure and development. Chemical etching follows to selectively remove the film not protected by the photoresist polymer so as to form the predetermined fusible elements 52 and termination pads 56.

However, the hybrid method of sputtering and plating techniques described above is too complicated, and fabricating cost is substantially high for the fusible elements 52 with a thickness more than 5 microns. Although thick film printing is a straightforward and affordable technique to fabricate the conductive film with a thickness more than 5 microns, it's not a fine technique since the line width is more than 200 microns practically.

The integration of thin film and thick film techniques offers a feasible solution to make the electrically conductive film that is more than 5 microns thick and around 20 to 200 microns wide. Firstly, a paste containing silver powder and glass powder is applied onto the top surface of the thermally insulating layer 61 by screen or stencil printing. The printed paste is dried to remove the solvent and heated to melt the glass to form an electrically conductive film of silver/glass composite after cooling. Silver serves as an electrical conductor and glass as adhesive media wherein the weight ratio of glass to silver is less than 15% in general.

A photoresist polymer is then patterned on the electrically conductive film of the silver/glass composite by coating, photo-exposure, and development. Chemical etching follows to remove the electrically conductive film not protected by the photoresist polymer. Finally, acetone or other suitable solvent strips the photoresist polymer to form an electrically conductive film having fine fusible elements 52. The photoresist polymer should be thicker than those popularly used in the thin film industry because the surface of the electrically conductive film of silver/glass composite is not quite flat by screen or stencil printing.

Etching of pure metal is straightforward and etching chemicals are commercially available. But, it's complicated to chemically etch alloy or composite consisting of two or more different compositions because it is not easy for etching chemicals to etch away all compositions simultaneously. To etch the electrically conductive film of silver/glass composite, etching chemicals are specially blended from the basic solutions of Nitric acid and Hydrofluoric acid in order to etch away silver and glass simultaneously.

According to the method described, a minimum width of 20 microns has been achieved for the electrically conductive film of silver/glass composite with a thickness of 5 microns. The integration of thin film and thick film techniques of the invention provides a straight forward and less costly method to fabricate the fusible elements 52.

Two termination pads 56 respectively connect with the two ends of each fusible element 52 to electrically link the fusible elements 52 with contact terminals. Termination pads 56 are usually wider than the fusible elements 52 so as to reduce resistance of the chip-type fuse and enlarge the contact area with the terminals. The material and thickness of termination pads 56 are preferred to be identical with those of the fusible elements 52 if possible. However, contact area and contact strength with the terminal will not be sufficient if the termination pads 56 are too thin, less than 1 micron for example. Therefore, increasing the thickness of thin termination pads 56 is required by means of plating or thick film printing.

As illustrated in FIG. 7, an arc suppressive layer 63 overlays and contacts each of the fusible elements 52 after fabrication of the fusible elements 52 and termination pads 56. Paste of arc suppressive layer 63 comprising glass is printed to cover the fusible elements 52 by screen or stencil and is dried to remove the solvent at 50 to 150° C. The thickness of the arc suppressive layer 63 can be increased by repeating the printing and drying steps. Afterwards, the substrate 51 is placed into a furnace to melt the glass at 500 to 700° C. preferably and form an arc suppressive layer 63 comprising glass after cooling.

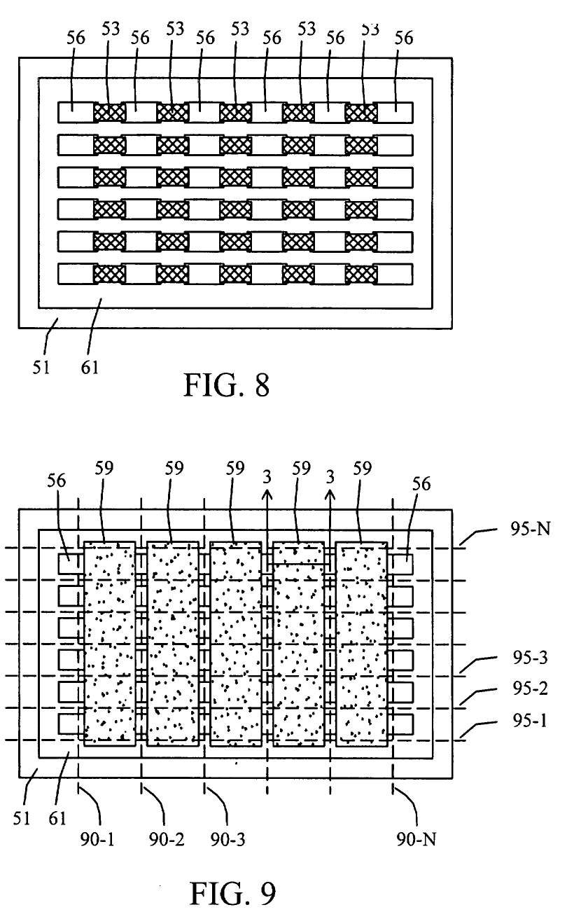

Referring to FIG. 8, a sacrificial layer 53 is formed on each of the arc suppressive layers 63. The sacrificial layer 53 primarily consists of polymeric resin that is required to shape easily and burn out below 400° C. preferably by reacting with oxygen. Acrylic resin is a good choice that can easily dissolve into Terpineol-based solvent or other suitable solvents to form a viscous paste that is printable by means of screen or stencil.

After removing solvent by drying at 50 to 150° C., the sacrificial layer 53 forms a predetermined shape and size. Its thickness can be increased by repeating the printing and drying steps. Alternatively, the sacrificial layers 53 can be formed by means of photo-exposure and development using photoresist polymer or other photosensitive polymer. In this way, the size is fine and precise but fabricating cost is much higher than that of printing.

As for the preferred embodiment illustrated in FIG. 2 and FIG. 3, the thermally insulating layers 61 and the arc suppressive layers 63 are not required. Therefore, the fusible elements 52 and the termination pads 56 are directly deposited onto the top surface of the substrate 51. The sacrificial layers 53 are then formed onto the fusible elements 52.

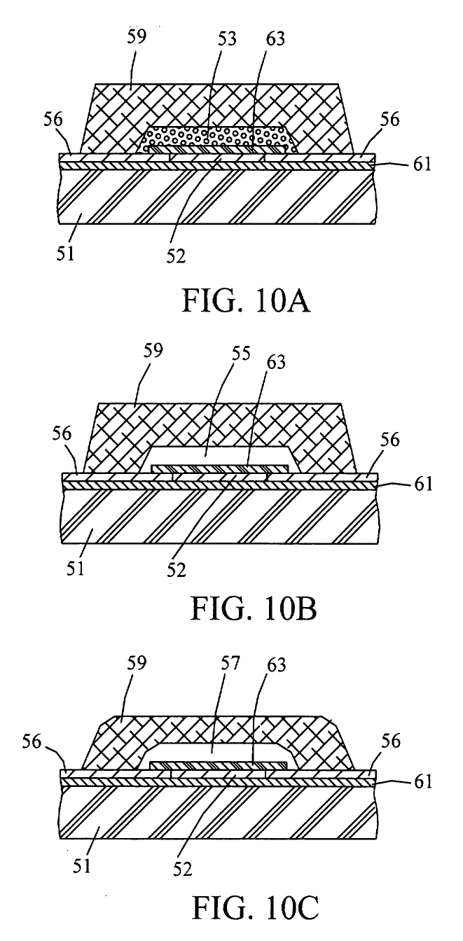

FIG. 9 illustrates the fabricating method of the protective layers 59 and the cavities 57. FIGS. 10A, 10B, and 10C are cross-sectional views taken partially from FIG. 9 along centerline of the fusible elements 52 (3-3 line). The protective layers 59 primarily consist of glass that has a melting temperature between 400 to 600° C. preferably. The first step is to print paste of protective layers 59 made of glass powders, binders, and solvents, to encapsulate the sacrificial layers 53 by screen or stencil. As illustrated in FIG. 10A, the printed paste is then dried to remove the solvents at 50 to 150° C. to form a predetermined shape and size, which is an assembly of glass powders and binders. The dried thickness can be increased to meet the requirement by repeating the printing and drying steps.

After that, the entire substrate 51 is placed inside a furnace to be heated up by 2 stages. The first stage is to set the temperature at 300 to 400° C. to remove the binders in atmospheric air. Referring to FIG. 10B, the polymeric resin of the sacrificial layer 53 reacts with the oxygen in the air to burn out as carbon dioxide and water vapor. An unsealed cavity 55 thus shapes in the space previously occupied by the sacrificial layer 53. By the way, the binders that bind glass powders of the protective layer 59 also burn out at this stage.

As shown in FIG. 10C, the second stage is to set the temperature at the melting point of the protective layer 59, preferably 400 to 600° C., in the environment of Nitrogen, Argon, air, or other suitable gases, depending upon the requirements. Glass powders of the protective layer 59 melt and solidify as a whole to be a dense structure and hermetically seal the cavity 57 after cooling. The height and outline of the cavity 57 will be changed somewhat during the melting process of the protective layer 59.

According to the ideal gas law, the pressure of a gas inside a closed chamber of fixed volume is proportional to the absolute temperature. Because the protective layer 59 melts at 400 to 600° C. in 1 atmosphere (760 mmHg), the pressure of the gas enclosed inside the cavity 57 should be less than 1 atmosphere, which is 300 mmHg around, after cooling down to room temperature.

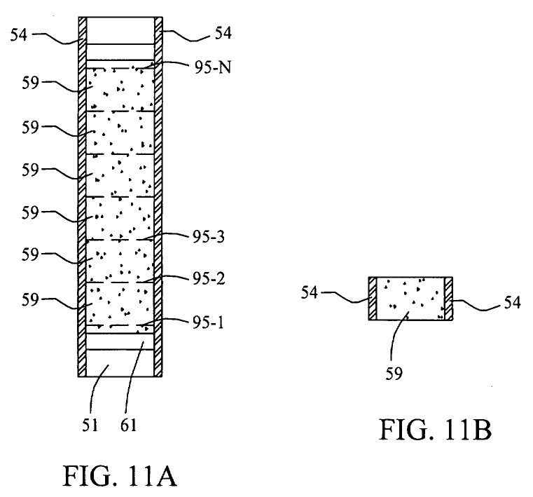

FIGS. 11A and 11B illustrate the method for fabricating terminals and the method for separating the fuses from the large substrate. Referring to FIG. 9 again, the protective layers 59 and the substrate 51 are diced by a diamond blade or laser. Parallel lines 95-1, 95-2, - - - 95-N indicate the dicing kerfs in the horizontal direction and pitch of the lines represents the width of individual chip-type fuse. Parallel lines 90-1, 90-2, - - - 90-N indicate the dicing kerfs in vertical direction and pitch of the lines represents the length of individual chip-type fuse.

Dicing starts from the horizontal direction according to parallel lines 95-1, 95-2, - - - 95-N to cut into, but not through, the substrate 51. Next, dicing in the vertical direction according to parallel lines 90-1, 90-2, - - - 90-N follows to cut through the substrate 51. Therefore, the large substrate 51 is divided into a plurality of strips of substrate as shown in FIG. 11A.

Afterwards, the inner layer metal for the terminals 54 is deposited onto the two ends of each strip of the substrate by sputtering a metallic film that has good adhesion to the substrate 51 such as pure metal or alloy of titanium and chromium. Alternatively, the inner layer metal can be silver-containing paste deposited by dipping or rolling. Drying and melting follow to form a conductive film containing silver. A middle layer of nickel is then plated onto the inner layer metal. Finally, an outer layer of tin is plated onto the nickel to complete the terminals 54.

Referring to FIG. 11B, the fabrication of chip-type fuses is completed by breaking each strip of the substrate into a plurality of individual chip-type fuses according to the diced kerfs 95-1, 95-2, - - - 95-N shown in FIG. 11A.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A chip-type fuse, comprising:
a substrate;
a fusible element disposed over said substrate;
a protective layer formed over said fusible element and adhering to said substrate around said fusible element;
a cavity formed between said fusible element and said protective layer and containing at least a portion of said fusible element; and
at least a terminal electrically connecting said fusible element.

2. The chip-type fuse of claim 1, wherein said substrate is electrically insulating and consists of alumina with more than 90% purity.

3. The chip-type fuse of claim 1, wherein said fusible element is electrically conductive and comprises a composite of silver and glass.

4. The chip-type fuse of claim 1, wherein said protective layer is homogeneous and electrically insulating that comprises glass material.

5. The chip-type fuse of claim 1, wherein at least a portion of said protective layer indirectly adheres to said substrate via at least an intermediate layer.

6. The chip-type fuse of claim 1, wherein said said protective layer adheres to said substrate around said fusible elements by melting as a whole.

7. The chip-type fuse of claim 1, wherein said cavity is hermetically sealed to enclose a gas and the pressure of said gas is less than one atmosphere.

8. The chip-type fuse of claim 1, wherein said at least a terminal is formed on the opposing side surfaces of said substrate and electrically connects with said fusible element at the end portions of said substrate.

9. The chip-type fuse of claim 1, further comprising a thermally insulating layer formed between said substrate and said fusible element.

10. The chip-type fuse of claim 9, wherein said thermally insulating layer comprises glass material.

11. The chip-type fuse of claim 1, further comprising an arc suppressive layer overlaying said fusible element and being interposed between said fusible element and said cavity.

12. The chip-type fuse of claim 11, wherein said arc suppressive layer comprises glass material.

13. The chip-type fuse of claim 1, further comprising at least a termination pad disposed over said substrate and electrically connecting said fusible element to the end portions of said substrate.

14. A chip-type fuse, comprising:
a substrate;
a thermally insulating layer formed over said substrate;
a fusible element disposed over said thermally insulating layer;
a protective layer formed over said fusible element and adhering to said thermally insulating layer around said fusible element; and
a cavity formed between said fusible element and said protective layer and containing at least a portion of said fusible element.

15. The chip-type fuse of claim 14, wherein at least a portion of said protective layer indirectly adheres to said thermally insulating layer via at least an intermediate layer.

16. The chip-type fuse of claim 14, wherein said cavity is hermetically sealed by melting the whole of said protective layer.

17. The chip-type fuse of claim 14, further comprising an arc suppressive layer overlaying said fusible element and being interposed between said fusible element and said cavity.

18. A method of manufacturing chip-type fuse including the steps of:
(a) providing a substrate;
(b) forming an electrically conductive film comprising a composite of silver and glass over said substrate;
(c) forming a photoresist polymer pattern on said electrically conductive film;
(d) etching said electrically conductive film that is not protected by said photoresist polymer pattern; and
(e) removing said photoresist polymer pattern to form an electrically conductive film with fine fusible element.

19. The method of claim 18, wherein said fusible element has a width of 20 to 200 microns and a thickness of 1 to 20 microns.
